(19) United States
(12) Patent Application Publication
(10) Pub. No.: US 2026/0017658 A1
(43) Pub. Date: Jan. 15, 2026

(54) SYSTEMS AND METHODS FOR FRAUD PREVENTION IN ELECTRONIC TRANSACTIONS BY IDENTIFYING AND LINKING TRANSACTIONS BY UNIQUE IDENTIFIERS

(71) Applicant: Worldpay, LLC, Symmes Township, OH (US)

(72) Inventors: Dmitriy BURMISTROV, Woburn, MA (US); Tao HONG, Acton, MA (US); Dennis A. KETTLER, Mason, OH (US)

(21) Appl. No.: 16/781,321

(22) Filed: Feb. 4, 2020

(51) Int. Cl. G06Q 20/40; G06F 16/22; G06Q 40/02

(52) U.S. Cl. CPC G06Q 20/4016; G06F 16/2272; G06Q 20/4018; G06Q 40/02

(57) ABSTRACT

A method for detecting fraudulent transactions may include receiving transaction data for a plurality of transactions, assigning a unique identifier to each transaction, sorting the plurality of transactions into a first plurality of groups of transactions by a first sorting parameter, assigning the unique identifier of a first transaction within each group to all other transactions within the respective group, sorting the plurality of transactions into a second plurality of groups of transactions by a second sorting parameter, assigning the unique identifier of a second transaction within each group to all other transactions within the respective group, determining whether each group of transactions is a sequence of fraudulent transactions, and upon determining that a group of transactions is a sequence of fraudulent transactions, marking each transaction among the determined group of transactions as potentially fraudulent.

### TECHNICAL FIELD

Various embodiments of the present disclosure relate generally to electronic transaction processing and, more particularly, to detection and prevention of fraudulent payment transactions.

### BACKGROUND

In the field of payments (e.g., credit or debit card or other electronic financial transactions), fraud detection technology may involve using historical payment transactions to build centralized card profiles where all transactions are linked to a common payment account number (“PAN”) of each credit card. The methods then use statistical or machine learning algorithms to score each transaction for a card based on its historical transactions and a calculated likelihood that fraud may be involved. Such systems may combine transaction scores with rule-based systems for detecting and preventing fraud. However, fraud is increasingly coming from fraud rings, e.g., involving a large number of cards and/or associated information from a data breach. Existing technology has difficulty with building complex relationships among the stolen financial information into a scored consumer behavior for effectively detecting and preventing this kind of organized fraud. The present disclosure is directed to overcoming one or more of these above-referenced challenges.

### SUMMARY OF THE DISCLOSURE

According to certain aspects of the present disclosure, systems and methods are disclosed for detecting fraudulent electronic transactions.

In one embodiment, a computer-implemented method is disclosed for detecting fraudulent transactions, the method comprising: receiving transaction data for a plurality of transactions, assigning a unique identifier to each transaction among the plurality of payment transactions, sorting the plurality of transactions into a first plurality of groups of transactions by a first sorting parameter, each transaction within each group of transactions among the first plurality of groups of transactions having the same value for the first sorting parameter, assigning the unique identifier of a first respective transaction within each group of transactions among the first plurality of groups of transactions to all other transactions within the respective group of transactions among the first plurality of groups of transactions, sorting the plurality of transactions into a second plurality of groups of transactions by a second sorting parameter, each transaction within each group of transactions among the second plurality of groups of transactions having the same value for the second sorting parameter, assigning the unique identifier of a second respective transaction within each group of transactions among the second plurality of groups of transactions to all other transactions within the respective group of transactions among the second plurality of groups of transactions, determining whether each group of transactions among the second plurality of groups of transactions is a sequence of fraudulent transactions, and upon determining that a group of transactions among the second plurality of groups of transactions is a sequence of fraudulent transactions, marking each transaction among the determined group of transactions as potentially fraudulent.

In accordance with another embodiment, a system is disclosed for detecting fraudulent transactions, the system comprising: a data storage device storing instructions for detecting fraudulent transactions in an electronic storage medium; and a processor configured to execute the instructions to perform a method including: receiving transaction data for a plurality of transactions, assigning a unique identifier to each transaction among the plurality of payment transactions, sorting the plurality of transactions into a first plurality of groups of transactions by a first sorting parameter, each transaction within each group of transactions among the first plurality of groups of transactions having the same value for the first sorting parameter, assigning the unique identifier of a first respective transaction within each group of transactions among the first plurality of groups of transactions to all other transactions within the respective group of transactions among the first plurality of groups of transactions, sorting the plurality of transactions into a second plurality of groups of transactions by a second sorting parameter, each transaction within each group of transactions among the second plurality of groups of transactions having the same value for the second sorting parameter, assigning the unique identifier of a second respective transaction within each group of transactions among the second plurality of groups of transactions to all other transactions within the respective group of transactions among the second plurality of groups of transactions, determining whether each group of transactions among the second plurality of groups of transactions is a sequence of fraudulent transactions, and upon determining that a group of transactions among the second plurality of groups of transactions is a sequence of fraudulent transactions, marking each transaction among the determined group of transactions as potentially fraudulent.

In accordance with another embodiment, a non-transitory machine-readable medium storing instructions that, when executed by the a computing system, causes the computing system to perform a method for detecting fraudulent transactions, the method including: receiving transaction data for a plurality of transactions, assigning a unique identifier to each transaction among the plurality of payment transactions, sorting the plurality of transactions into a first plurality of groups of transactions by a first sorting parameter, each transaction within each group of transactions among the first plurality of groups of transactions having the same value for the first sorting parameter, assigning the unique identifier of a first respective transaction within each group of transactions among the first plurality of groups of transactions to all other transactions within the respective group of transactions among the first plurality of groups of transactions, sorting the plurality of transactions into a second plurality of groups of transactions by a second sorting parameter, each transaction within each group of transactions among the second plurality of groups of transactions having the same value for the second sorting parameter, assigning the unique identifier of a second respective transaction within each group of transactions among the second plurality of groups of transactions to all other transactions within the respective group of transactions among the second plurality of groups of transactions, determining whether each group of transactions among the second plurality of groups of transactions is a sequence of fraudulent transactions, and upon determining that a group of transactions among the second plurality of groups of transactions is a sequence of fraudulent transactions, marking each transaction among the determined group of transactions as potentially fraudulent.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary scenario in which fraudulent payment transactions may be attempted.

FIG. 2A-2F depict sequences of payment transactions during processing to detect potentially fraudulent transactions, according to one or more embodiments.

FIG. 3 depicts a block diagram of a payment system comprising a fraud detection computing system infrastructure and authorization processor for fraud prevention by transaction and account identifier linking, according to one or more embodiments.

FIG. 4 depicts a flowchart of a method of fraud prevention by transaction and card linking, according to one or more embodiments.

FIG. 5 depicts an example of a computing device for fraud prevention by transaction and account identifier linking, according to one or more embodiments.

### DETAILED DESCRIPTION OF EMBODIMENTS

Various embodiments of the present disclosure relate generally to detection and prevention of fraudulent payment transactions by transaction and account identifier linking.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

As discussed above, the increasing frequency and scope of data breaches from merchants, banks, and credit bureaus has resulted in widespread partially or completely stolen information about consumer payment account identifiers, addresses and other information that can potentially be used for fraudulent purpose. Fortunately, most such data breaches are limited to revealing partial data, such as incomplete payment account identifiers, such as credit card numbers, or billing names and addresses. In cases when the stolen consumer information is incomplete, a fraudster may use a “Card Testing” strategy, either manually or by brute force. In a card testing scheme, the fraudster may try to get authorization approval for one or more transactions for a small payment amount in a card-not-present environment, such as an online transaction. These card testing transactions may be submitted, for example, to non-profit organizations and membership subscription services to potentially take advantage of less robust fraud protection processes in place than at a merchant. However, card testing transactions may be submitted to any organization or merchant that processes online payment transactions.

For example, if a stolen payment account number is incomplete, the fraudster may try to use the payment account number with a non-profit organization donation website multiple times by substituting the missing parts of the account identifier, such as a payment card number. Or, if a complete account identifier was stolen but the ZIP code associated with the payment account is unknown, the fraudster may try to use the card multiple times with different ZIP codes substituted. Other missing data may be systematically substituted in a similar manner. The fraudster may submit transactions among the sequence of transactions to multiple different merchants or organizations in order to avoid suspicion. After successful completion of a payment transaction with a small payment amount, the fraudster may attempt a payment transaction for expensive goods, such as, for example, jewelry or electronics, using the same payment credentials at other online merchants.

In general, a card testing pattern is difficult to predict, though there are some general red flags for the card testing. For example, because the purpose of card testing is to reconstruct missing customer information or just to check if the payment account information works at all, using the payment information with multiple merchants selling cheap goods or services may suggest that the transactions are potentially fraudulent. Another potential indicator of fraudulent activity is submission of multiple transactions with some data elements fixed, such as the payment account number, but other data elements varying, such as the ZIP code.

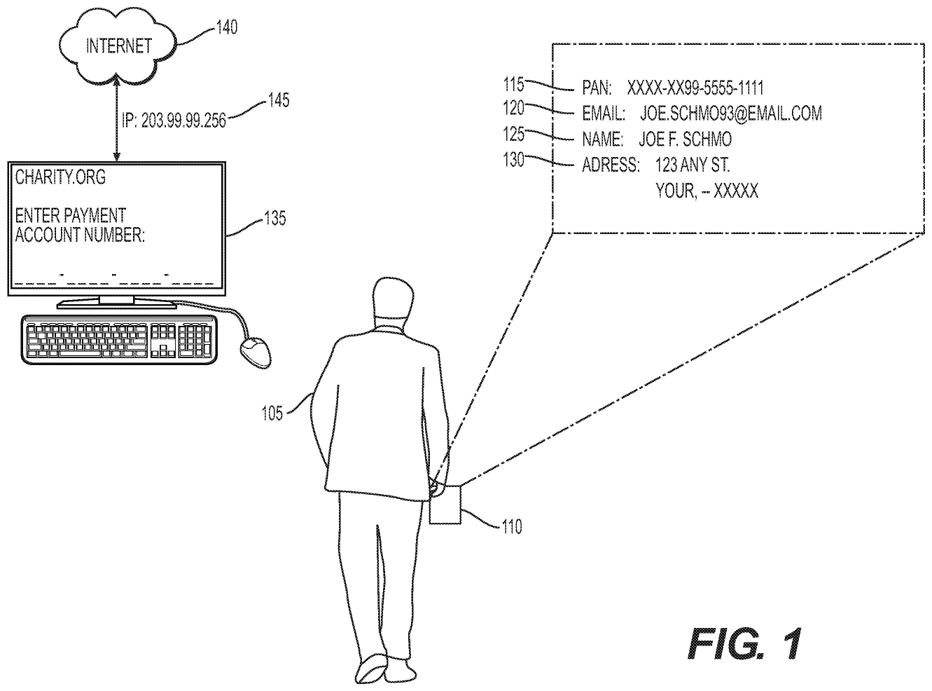

As shown in FIG. 1, in such a scenario, fraudster 105 may be in possession of stolen financial account information 110. Stolen financial account information 110 may include some information that is complete, such as customer name 125 and email address 120. Other items of information may be incomplete, such as payment account number (PAN) 115 with missing digits or billing address 130 with missing state code and zip code. Fraudster 105 may attempt to determine the missing information by submitting a sequence of transactions with the missing information systematically filled in. Fraudster 105 may do so using a computing device 135, such as a computer, tablet, or mobile device, to submit payment transactions to any type of online merchant, charitable organization, membership organization, or a combination thereof. The sequence of transactions may be submitted over a computer network, such as the Internet 140 using the IP address 145 associated with computing device 135.

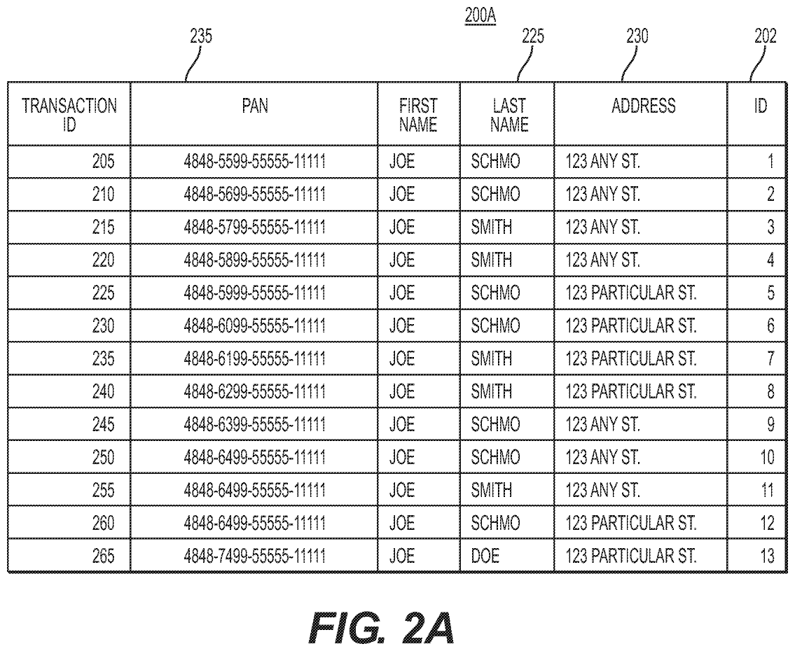

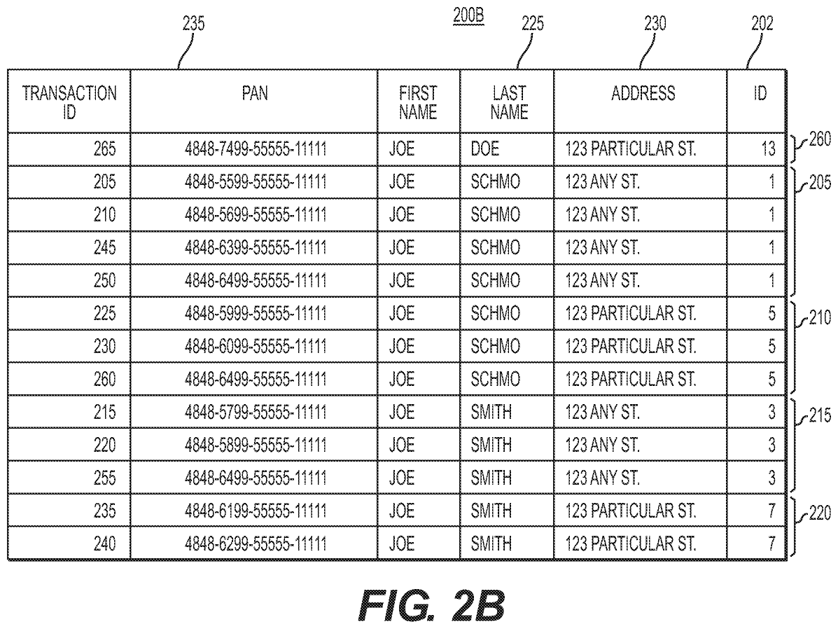

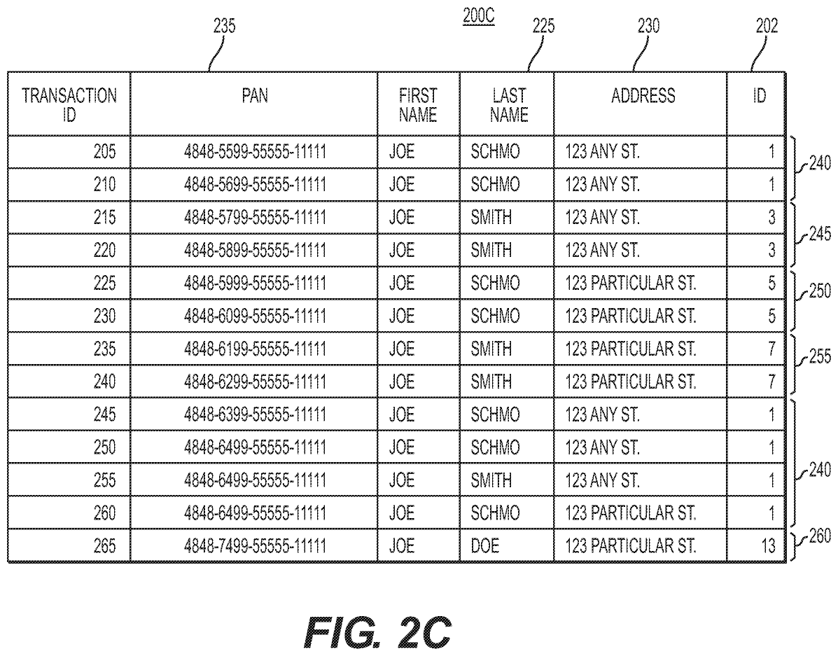

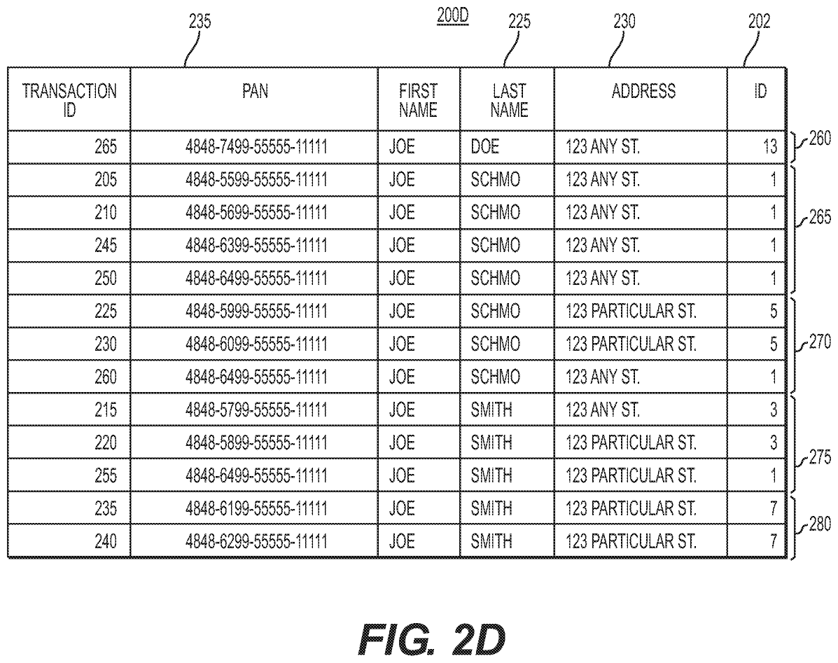

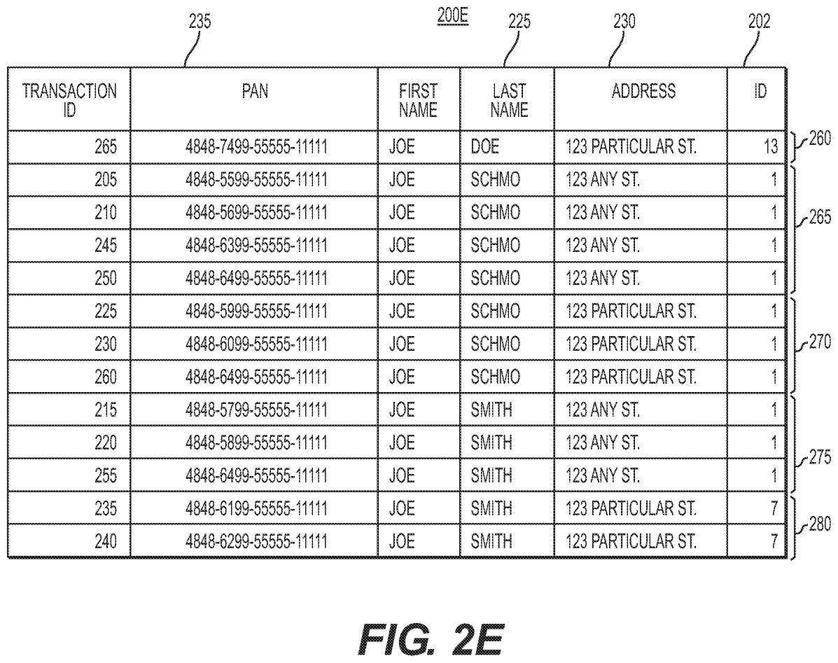

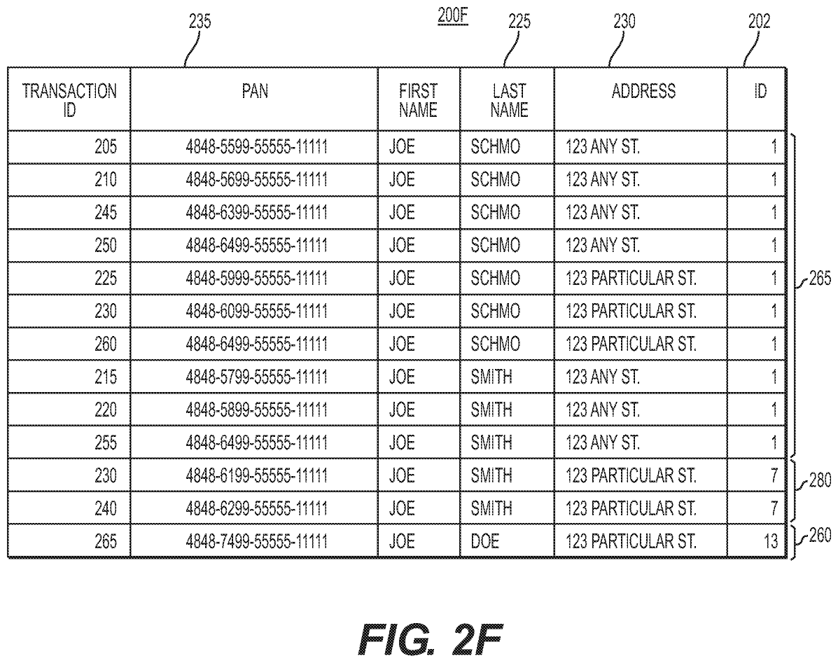

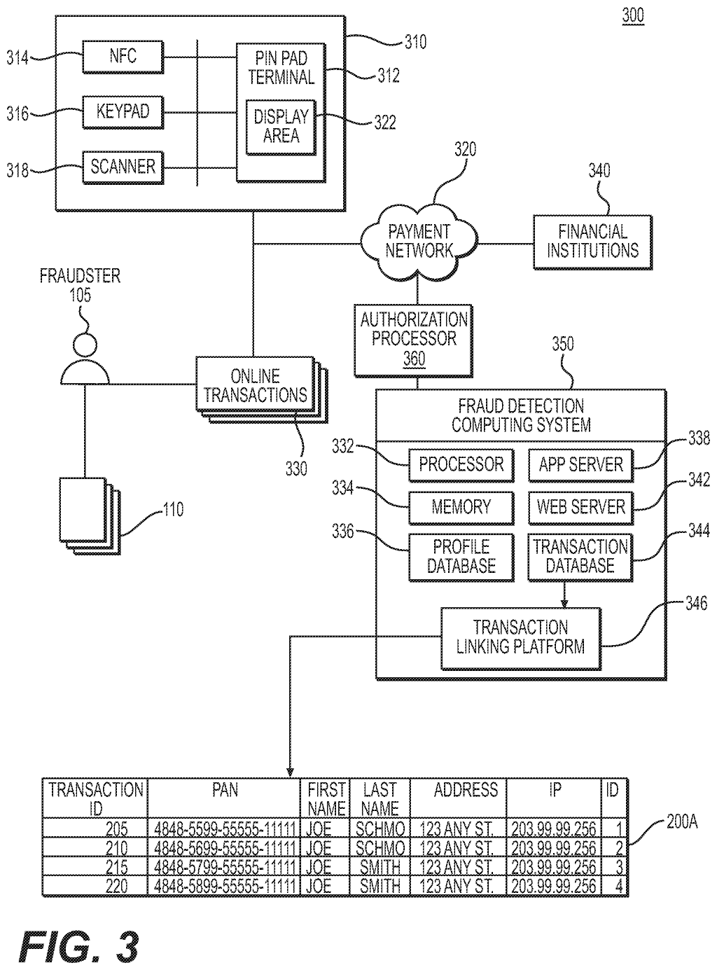

Detecting fraudulent activity under a card testing strategy may be challenging because often a merchants sees a single transaction in the sequence or a small subset of the sequence. Embodiments of the present disclosure may overcome these obstacles by grouping payment transactions across multiple merchants, or other organizations, and linking transactions together through common values of transaction parameters, such as, for example, payment account number (PAN), email address, billing address and surname, phone number and surname, billing address and phone number, or IP address. This may be implemented as a stand-alone system, integrated into existing fraud product, such as at an acquirer processor such as authorization processor 360 shown in FIG. 3, or as independent third-party data for various stakeholders in payment ecosystem. With this methodology, complex relations between cards which would otherwise seem to be completely unrelated events can be identified. Embodiments will be described in greater detail below with respect to FIGS. 2A-2F, and 3-5.

Any suitable system infrastructure may be put into place to allow detection and prevention of fraudulent payment transactions by transaction and card linking. FIGS. 3-5 and the following discussion provide a brief, general description of a suitable computing environment in which the present disclosure may be implemented. In one embodiment, any of the disclosed systems, methods, and/or graphical user interfaces may be executed by or implemented by a computing system consistent with or similar to that depicted in FIG. 3. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Turning to FIG. 3, an exemplary system infrastructure is depicted for payment processing within a merchant environment, according to one or more embodiments. In an example embodiment, a user (e.g., fraudster 105) may use one or more payment vehicles to conduct transactions with one or more merchants or other payment processors 310 through a payment system 300. As shown in FIG. 3, merchant 310 may provide infrastructure for processing electronic payment requests. In one of many scenarios, a consumer may pay for goods or services from merchant 310 at a PIN pad terminal 312 associated with a point-of-sale (“POS”) terminal. In one embodiment, an authorization processor 360 that handles financial transactions may transfer payment between the financial institution 340 of consumer and that of merchant 310.

In an in-person transaction, the consumer may submit payment information at the PIN pad 312 associated with the merchant's POS terminal by swiping his/her payment card, inserting his/her chip-based payment card, through wireless near field communication (NFC), through a payment app, via a Quick Response code (“QR” code), etc., or by any other suitable means. PIN pad 312 may send a payment authorization request by way of a computer network 320 to an authorization processor 360 (e.g., one of financial institutions 340). Alternatively, such a request may be sent by a component that controls a flow of a transaction, such as point of sale (POS) engine. The authorization processor 360 may request, by way of payment network 320, an electronic transfer of funds from the received funds to the financial institution 340 associated with merchant 310.

However, in some scenarios, a person or entity, such as fraudster 105, may submit payment transactions through an online electronic interface rather than in person. In some scenarios, such as is depicted in FIG. 1, the person submitting online payment transactions 330 may possess fraudulently obtained financial account information 110, and may base the submitted online transactions 330 on fraudulently obtained financial account information 110. As discussed above with respect to FIG. 1, in some cases, fraudulently obtained financial account information 110 may be incomplete, and fraudster 105 may submit numerous online transactions in order to find matches for any missing information that will allow a payment transaction to be completed. Authorization processor 360, or another financial institution, may include infrastructure, such as fraud detection computing system 350, for detecting such a sequence of attempted transactions in order to detect and prevent attempted fraudulent transactions. As discussed in detail below, such detection may be accomplished by linking the attempted fraudulent transactions and associated financial information such as payment account numbers.

In general, a fraud detection computing system 350 may be operated by an authorization processor, issuer processor, card issuer, or any other financial institution 340. The fraud detection computing system 350 may be operated by another entity or operated independently. In any event, fraud detection computing system 350 and authorization processor 360 may be configured to intercept authorization requests sent across payment network 320, or otherwise receive data about payment transactions sent between merchants 310 and financial institutions 340.

In an example embodiment, a fraud detection computing system 350 may comprise processor 332, memory 334, profile database 336, application server 338, web server 342, transaction database 344, and transaction linking platform 346. The profile database 336 for an individual user may store a unique identifier hash recognizing the profile of the user, primary account numbers (e.g., PANs) or other identifiers of payment accounts (e.g. debit, credit cards, mobile applications, etc.) associated with the user, personally identifiable information (PII), and/or data/analysis of transaction requests associated with the user.

Processor 332 may send a notification to the financial institutions 340 reporting fraudulent activity it determines among requested authorizations of either online or brick-and-mortar payment transactions. The financial institutions 340 and the authorization processor 360 may reject the online or brick-and-mortar payment transaction according to the notification.

The transaction database 344 may store transaction data for payment transactions processed by authorization processor 360. A plurality of transaction parameters associated with each transaction may be stored as transaction data. Transaction parameters may include account number, account identifier such as a card number, payment vehicle information, product information (e.g., product identifier, product type, product serial number, etc.), transaction amount, loyalty account information, merchant information (e.g., source ID, terminal ID, IP address, transaction location, etc.), transaction date and time, whether the transaction was a ‘card present’ transaction, etc. In one embodiment, transaction database 344 may be generated by retrieving historical transaction data from an online or brick-and-mortar payment transaction before the online or brick-and-mortar payment transaction is sent to a financial institution for authorization.

The transaction linking platform 346 may perform analysis on a sequence of transactions, such as transaction sequence 200A shown in FIG. 2A, in order to link related transactions and, thereby, determine which transactions may belong to a sequence of fraudulent card testing transactions. For example, transaction linking platform 346 may assign a unique identifier 202 to each transaction and then sort the sequence of transactions by a parameter or a combination of parameters to form multiple groups of transactions. The sorting parameter or parameters may include, for example, a payment card or account number, an email address, an account holder first name, an account holder surname, a phone number, a payment account street address, a payment account state code, a payment account zip code, a card verification value (CVV), a transaction amount, and an internet protocol (IP) address of a device from which the respective transaction originated, etc. The sorting parameter may be a single transaction parameter, such as the payment account number 235, or may be a combination of transaction parameters, such as the billing address 230 and account holder's surname 225. The sorting parameter or parameters may be selected appropriately to maintain uniqueness among the parameters to identify an account holder. Each transaction having the same value for the sorting parameter may then be assigned the same identifier such as, for example, the minimum originally assigned identifier in each group of transactions, the originally assigned identifier for the first transaction in each group of transactions, or the originally assigned identifier for a randomly chosen transaction in each group of transactions. For example, as shown in FIG. 2B, the sequence of transactions may be sorted by a combination of surname 225 and billing address 230. In this example, transactions having the surname “Schmo” and the billing address “123 Any St.” may form group 205 and may each be assigned identifier 1 as a respective transaction within group 205. Other combinations of surname and billing address are, likewise, assigned common identifiers in groups 210, 215, 220, and 260. The sequence of transactions may be sorted again by another transaction parameter or combination of transaction parameters. For example, as shown in FIG. 2C, the sequence of transactions may be sorted by the payment account number (PAN) 235 to form groups 240, 245, 250, 255, and 260. Each transaction having the same value for the PAN may then be assigned the same identifier 202. FIG. 2D further shows another iteration of sorting the transactions by the combination of surname 225 and billing address 230. As shown in FIG. 2D, groups 260, 265, 270, 275, and 280 may be formed. In this example, groups 270 and 275 include transactions having different identifiers. The transactions in each group may be assigned a common identifier, such as, for example, the minimum identifier among the transactions in the group. FIG. 2E illustrates each transaction in each group with an identifier assigned as the minimum identifier among the transactions in the group. This procedure of sorting and assigning new identifiers, as depicted in FIGS. 2A-2E may be repeated until a convergence criterion is met. For example, until no transaction changes a previously assigned identifier. In general, it may require 10-30 iterations to reach the convergence of the identifier. The transactions may then be sorted by the assigned identifiers to identify related transactions, such as the transactions in group 265. In this example, as shown in FIG. 2F, the first ten transactions in group 265, each assigned identifier “1,” may be determined to be linked potentially fraudulent transactions. Transactions in a group of transactions may be determined to be a sequence of fraudulent transactions based on, for example, one or more of a frequency of transactions with a single payee, transaction amounts of each transaction among the group of transactions, a pattern of changes to a transaction parameter within the group of transactions, a total count of unique cards used, a total count of unique full names used, or a common missing transaction parameter within the group of transactions. In addition, a group of transactions may be determined to be a sequence of fraudulent transactions based on the presence of an unreasonably large number of unique cards in a group, such as, for example, more than 1000 unique cards. Such a threshold may be adjustable based on a mean or median number of unique cards per card holder, or it may be adjustable to achieve a higher or lower sensitivity to potential fraud. Multiple rounds of sorting by differing combinations of transaction parameters, possibly including 10, 20, or more rounds, may be required before all related transactions may be identified. The iterative sorting process may end when the group identifier converges, i.e., there are no further change to the assigned identifiers, or only a small number of identifier changes occur. For example, the iterative sorting process may end when fewer than 1% of assigned identifiers are modified. Additional analysis of the identified transactions may be needed in order to reject any of the determined transactions as fraudulent. For example, the identified transactions may be filtered to eliminate transactions with known legitimate parameters, but other indicators of a potentially fraudulent transaction. Furthermore, additional information may put the identified transactions in a “white list” of legitimate transactions. For example, if a number of unique cards in a group of transactions is greater than 1000, but the large number of cards can be explained by a card holder specifics, such as a small business sharing the same commercial card accounts, or a group of transactions has more 1000 unique addresses, but the transactions relate to a company that actually has more than 1000 branches. If such a “white list” is not available then false positives may be reduced by defining very high thresholds for card testing detection, such as, for example, more than 1,000,0000 unique cards. Known or confirmed fraudulent transactions, such as those identified by banks, payment networks, and acquirer processors may also be used to mark transactions in the group and help to identify other potential fraudulent transactions in the group. Once a transaction has been determined to be part of a sequence of fraudulent transactions, transaction linking platform 346 may report the transaction to authorization processor 360 for further processing. For example, authorization processor 360 may deny the payment transaction, may report the suspect transaction to the holder of the payment account, or may approve the transaction based on other factors.

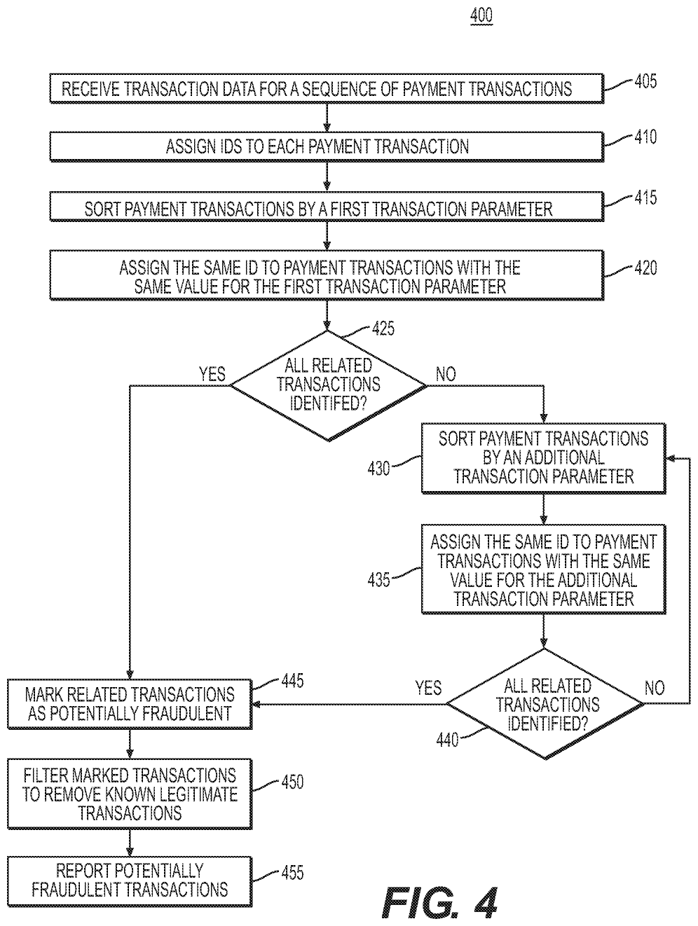

FIG. 4 depicts a flowchart of a method 400 of fraud prevention by transaction and card linking, according to one or more embodiments. As shown in FIG. 4, in operation 405, transaction linking platform 346 may receive transaction data for a sequence of payment transactions. In operation 410, transaction linking platform 346 may assign original identifiers to each payment transaction. The originally assigned identifiers may be sequential or may be random, and may be globally unique among all processed transactions or may be unique only within the sequence of transactions to be analyzed. In operation 415, transaction linking platform 346 may sort payment transactions by a first transaction parameter. In operation 420, transaction linking platform 346 may assign the same identifier to payment transactions with the same value for the first transaction parameter. In operation 425, transaction linking platform 346 may determine whether all related transactions have been identified, such, for example, by determining that no transactions, or a small percentage of transactions, changed identifiers in the last iteration. The process of sorting transactions and assigning identifiers may proceed through each of the transaction parameters in turn. If sorting on all parameters has been performed once, but all related transactions have not been identified, the process may sort by one or more transaction parameters again. If all related transactions have been identified, then processing may continue with step 445. If all related transactions have not been identified, then in operation 430, transaction linking platform 346 may sort payment transactions by an additional transaction parameter. In operation 435, transaction linking platform 346 may assign the same identifier to payment transactions with the same value for the additional transaction parameter. In operation 440, transaction linking platform 346 may determine whether all related transactions have been identified. If all related transactions have been identified, then processing may continue with step 445. If all related transactions have not been identified, then processing may return to step 430. In operation 445, transaction linking platform 346 may mark related transactions as potentially fraudulent. In operation 450, transaction linking platform 346 may filter marked transactions to remove known legitimate transactions. In operation 455, transaction linking platform 346 may report potentially fraudulent transactions.

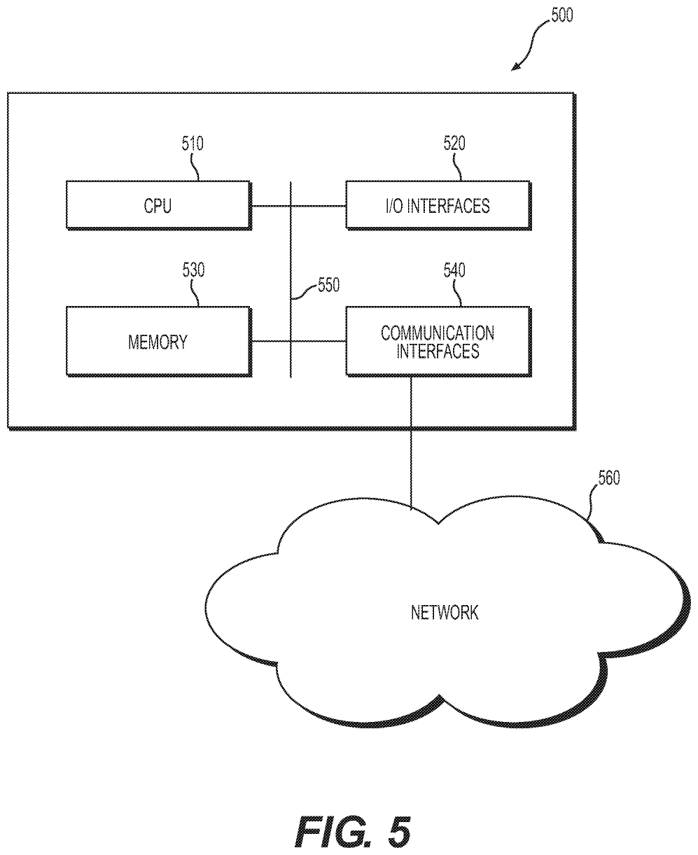

FIG. 5 illustrates an example computing device for fraud prevention by transaction and card linking. A computing device 500 may be a server, a computing device that is integrated with other systems or subsystems, a mobile computing device such as a smart phone, a cloud-based computing ability, and so forth. The computing device 500 may be any suitable computing device as would be understood in the art, including without limitation, a custom chip, and embedded processing device, a tablet computing device, a POS terminal associated with a merchant (e.g., merchant 310), a back-office system of a merchant, a personal data assistant (PDA), a desktop, laptop, microcomputer, and minicomputer, a server, a mainframe, or any other suitable programmable device. In various embodiments disclosed herein, a single component may be replaced by multiple components and multiple components may be replaced by single component to perform a given function or functions. Except where such substitution would not be operative, such substitution is within the intended scope of the embodiments.

The computing device 500 may include a processor 510 that may include any suitable type of processing unit, for example a general-purpose central processing unit (CPU), a reduced instruction set computer (RISC), a processor that has a pipeline or multiple processing capability including having multiple cores, a complex instruction set computer (CISC), a digital signal processor (DSP), application specific integrated circuits (ASIC), a programmable logic devices (PLD), and a field programmable gate array (FPGA), among others. The computing resources may also include distributed computing devices, cloud computing resources, and virtual computing resources in general.

The computing device 500 may also include one or more memories 530, for example a read-only memory (ROM), random access memory (RAM), cache memory associated with the processor 510, or other memory such as dynamic RAM (DRAM), static RAM (SRAM), programmable ROM (PROM), electrically erasable PROM (EEPROM), flash memory, a removable memory card or disc, a solid-state drive, and so forth. The computing device 500 also includes storage media such as a storage device that may be configured to have multiple modules, such as magnetic disk drives, floppy drives, tape drives, hard drives, optical drives and media, magneto-optical drives and media, compact disk drives, Compact Disc Read Only Memory (CD-ROM), compact disc recordable (CD-R), Compact Disk Rewritable (CD-RW), a suitable type of Digital Versatile Disc (DVD) or BluRay disc, and so forth. Storage media such as flash drives, solid-state hard drives, redundant array of individual discs (RAID), virtual drives, networked drives and other memory means including storage media on the processor 510, or memories 530 are also contemplated as storage devices. It may be appreciated that such memory may be internal or external with respect to operation of the disclosed embodiments. It may be appreciated that certain portions of the processes described herein may be performed using instructions stored on a computer readable medium or media that direct computer system to perform the process steps. Non-transitory computable-readable media, as used herein, comprises all computer-readable media except for transitory, propagating signals.

One or more networking communication interfaces 540 may be configured to transmit to, or receive data from, other computing devices 500 across a network 560. The network and communication interfaces 540 may include an Ethernet interface, a radio interface, a Universal Serial Bus (USB) interface, or any other suitable communications interface and may include receivers, transmitter, and transceivers. For purposes of clarity, a transceiver may be referred to as a receiver or a transmitter when referring to only the input or only the output functionality of the transceiver. Example communication interfaces 540 may include wire data transmission links such as Ethernet and TCP/IP. The communication interfaces 540 may include wireless protocols for interfacing with private or public networks 560. For example, the network and communication interfaces 540 and protocols may include interfaces for communicating with private wireless networks such as Wi-Fi network, one of the IEEE 802.11x family of networks, or another suitable wireless network. The network and communication interfaces 540 may include interfaces and protocols for communicating with public wireless networks 560, using for example wireless protocols used by cellular network providers, including Code Division Multiple Access (CDMA) and Global System for Mobile Communications (GSM). A computing device 500 may use network and communication interfaces 540 to communicate with hardware modules such as a database or data store, or one or more servers or other networked computing resources. Data may be encrypted or protected from unauthorized access.

In various configurations, the computing device 500 may include a system bus 550 for interconnecting the various components of the computing device 500, or the computing device 500 may be integrated into one or more chips such as programmable logic device or application specific integrated circuit (ASIC). The system bus 550 may include a memory controller, a local bus, or a peripheral bus for supporting input and output device interfaces 520, and communication interfaces 540. Example input and output interfaces or devices 520 include keyboards, keypads, gesture or graphical input devices, motion input devices, touchscreen interfaces, one or more displays, audio units, voice recognition units, vibratory devices, computer mice, and any other suitable user interface.

The processor 510 and memory 530 may include nonvolatile memory for storing computable-readable instructions, data, data structures, program modules, code, microcode, and other software components for storing the computer-readable instructions in non-transitory computable-readable mediums in connection with the other hardware components for carrying out the methodologies described herein. Software components may include source code, compiled code, interpreted code, executable code, static code, dynamic code, encrypted code, or any other suitable type of code or computer instructions implemented using any suitable high-level, low-level, object-oriented, visual, compiled, or interpreted programming language.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

1. A computer-implemented method comprising:
intercepting, by a processor, authorization requests sent across a payment network for a plurality of transactions involving a plurality of merchants or other organizations, wherein the processor accesses a database storing hashed identifiers associated with one or more users of the plurality of transactions;
assigning, by the processor, a unique transaction identifier to each transaction among the plurality of payment transactions, each unique transaction identifier being unique among the identifiers assigned to the plurality of transactions and uniquely identifying the transaction to which it is assigned;
sorting, by the processor, the plurality of transactions into a first plurality of groups of transactions by a first sorting parameter, each transaction within each group of transactions among the first plurality of groups of transactions having a same value for the first sorting parameter;
assigning, by the processor, the unique transaction identifier of a first respective transaction within each group of transactions among the first plurality of groups of transactions to all other transactions within the respective group of transactions among the first plurality of groups of transactions;
sorting, by the processor, the plurality of transactions into a second plurality of groups of transactions by a second sorting parameter, each transaction within each group of transactions among the second plurality of groups of transactions having the same value for the second sorting parameter;
assigning, by the processor, the unique transaction identifier of a second respective transaction within each group of transactions among the second plurality of groups of transactions to all other transactions within the respective group of transactions among the second plurality of groups of transactions;
determining, by the processor, that a convergence criterion is met based on no transactions changing a previously-assigned identifier over a predefined number of iterations, wherein the iterations include repeatedly sorting and assigning the unique transaction identifier based on predefined criteria until the previously-assigned identifier remains unchanged;
determining, by the processor, whether each group of transactions among the second plurality of groups of transactions is a sequence of fraudulent transactions based on (i) determining that the convergence criterion is met and (ii) one or more features including a transaction frequency metric, a distribution of transaction value, a temporal or structural pattern of modifications to transaction parameters, or an indicator of missing transaction parameter;
determining, by the processor, whether the group of transactions exceed a predefined threshold of a potentially fraudulent activity, wherein the predefined threshold is based on a count of one or more unique account numbers, one or more unique billing addresses, or one or more unique phone numbers;
filtering, by the processor, one or more transactions with known legitimate parameters from the group of transactions identified as potentially fraudulent, wherein the known legitimate parameters include transactions associated with one or more predefined transaction patterns or exceptions;
upon determining that a group of transactions among the second plurality of groups of transactions is a sequence of fraudulent transactions, denying, by the processor, respective authorization requests for each transaction among the determined group of transactions from among the authorization requests sent across the payment network; and
transmitting electronic reports that respectively report transactions associated with the respective denied authorization requests to respective holders of payment accounts associated with the respective transactions.

2. The computer-implemented method of claim 1, further comprising:
determining, by the processor, whether each transaction among the determined group of transactions is legitimate; and
upon determining that a transaction among the determined group of transactions is legitimate, marking, by the processor, the transaction as not potentially fraudulent.

3. (canceled)

4. The computer-implemented method of claim 1, wherein one or more operations of sorting the plurality of transactions, and assigning, by the processor, the unique transaction identifier of a respective transaction to all other transactions within the respective group of transactions, are repeated until all related transactions are grouped together.

5. The computer-implemented method of claim 1, wherein the first sorting parameter and the second sorting parameter comprise one of a payment account number, an account holder first name, an account holder surname, a payment account street address, a payment account state code, a payment account zip code, a card verification value (CVV), a transaction amount, and an internet protocol (IP) address of a device from which the respective transaction originated.

6. The computer-implemented method of claim 1, wherein the first sorting parameter and the second sorting parameter comprise two or more of a payment account number, an account holder first name, an account holder surname, a payment account street address, a payment account state code, a payment account zip code, a card verification value (CVV), a transaction amount, and an internet protocol (IP) address of a device from which the respective transaction originated.

7. The computer-implemented method of claim 1, wherein determining, by the processor, whether each group of transactions is a sequence of fraudulent transactions is based on a pattern of changes to a transaction parameter within the group of transactions or a common missing transaction parameter within the group of transactions.

8. A system comprising:
a data storage device storing instructions for detecting fraudulent transactions in an electronic storage medium; and
a processor configured to execute the instructions to perform a method including:
intercepting authorization requests sent across a payment network for a plurality of transactions involving a plurality of merchants or other organizations, wherein the processor accesses a database storing hashed identifiers associated with one or more users of the plurality of transactions;
assigning a unique transaction identifier to each transaction among the plurality of payment transactions, each unique transaction identifier being unique among the identifiers assigned to the plurality of transactions and uniquely identifying the transaction to which it is assigned;
sorting the plurality of transactions into a first plurality of groups of transactions by a first sorting parameter, each transaction within each group of transactions among the first plurality of groups of transactions having a same value for the first sorting parameter;
assigning the unique transaction identifier of a first respective transaction within each group of transactions among the first plurality of groups of transactions to all other transactions within the respective group of transactions among the first plurality of groups of transactions;
sorting the plurality of transactions into a second plurality of groups of transactions by a second sorting parameter, each transaction within each group of transactions among the second plurality of groups of transactions having the same value for the second sorting parameter;
assigning the unique transaction identifier of a second respective transaction within each group of transactions among the second plurality of groups of transactions to all other transactions within the respective group of transactions among the second plurality of groups of transactions;
determining that a convergence criterion is met based on no transactions changing a previously-assigned identifier over a predefined number of iterations, wherein the iterations include repeatedly sorting and assigning the unique transaction identifier based on predefined criteria until the previously-assigned identifier remains unchanged;
determining whether each group of transactions among the second plurality of groups of transactions is a sequence of fraudulent transactions based on (i) determining that the convergence criterion is met and (ii) one or more features including a transaction frequency metric, a distribution of transaction value, a temporal or structural pattern of modifications to transaction parameters, or an indicator of missing transaction parameter;
determining whether the group of transactions exceed a predefined threshold of a potentially fraudulent activity, wherein the predefined threshold is based on a count of one or more unique account numbers, one or more unique billing addresses, or one or more unique phone numbers;
filtering one or more transactions with known legitimate parameters from the group of transactions identified as potentially fraudulent, wherein the known legitimate parameters include transactions associated with one or more predefined transaction patterns or exceptions;
upon determining that a group of transactions among the second plurality of groups of transactions is a sequence of fraudulent transactions, denying, by the processor, respective authorization requests for each transaction among the determined group of transactions from among the authorization requests sent across the payment network; and
transmitting electronic reports that respectively report transactions associated with the respective denied authorization requests to respective holders of payment accounts associated with the respective transactions.

9. The system of claim 8, wherein the system is further configured for:
determining whether each transaction among the determined group of transactions is legitimate; and
upon determining that a transaction among the determined group of transactions is legitimate, marking the transaction as not potentially fraudulent.

10. (canceled)

11. The system of claim 8, wherein one or more operations of sorting the plurality of transactions, and assigning the unique transaction identifier of a respective transaction to all other transactions within the respective group of transactions, are repeated until all related transactions are grouped together.

12. The system of claim 8, wherein the first sorting parameter and the second sorting parameter comprise one of a payment account number, an account holder first name, an account holder surname, a payment account street address, a payment account state code, a payment account zip code, a card verification value (CVV), a transaction amount, and an internet protocol (IP) address of a device from which the respective transaction originated.

13. The system of claim 8, wherein the first sorting parameter and the second sorting parameter comprise two or more of a payment account number, an account holder first name, an account holder surname, a payment account street address, a payment account state code, a payment account zip code, a card verification value (CVV), a transaction amount, and an internet protocol (IP) address of a device from which the respective transaction originated.

14. The system of claim 8, wherein determining whether each group of transactions is a sequence of fraudulent transactions is based on a pattern of changes to a transaction parameter within the group of transactions or a common missing transaction parameter within the group of transactions.

15. A non-transitory machine-readable medium storing instructions that, when executed by a computing system, causes the computing system to perform a method including:
intercepting authorization requests sent across a payment network for a plurality of transactions involving a plurality of merchants or other organizations, wherein a processor accesses a database storing hashed identifiers associated with one or more users of the plurality of transactions;
assigning a unique transaction identifier to each transaction among the plurality of payment transactions, each unique transaction identifier being unique among the identifiers assigned to the plurality of transactions and uniquely identifying the transaction to which it is assigned;
sorting the plurality of transactions into a first plurality of groups of transactions by a first sorting parameter, each transaction within each group of transactions among the first plurality of groups of transactions having a same value for the first sorting parameter;
assigning the unique transaction identifier of a first respective transaction within each group of transactions among the first plurality of groups of transactions to all other transactions within the respective group of transactions among the first plurality of groups of transactions;
sorting the plurality of transactions into a second plurality of groups of transactions by a second sorting parameter, each transaction within each group of transactions among the second plurality of groups of transactions having the same value for the second sorting parameter;
assigning the unique transaction identifier of a second respective transaction within each group of transactions among the second plurality of groups of transactions to all other transactions within the respective group of transactions among the second plurality of groups of transactions;
determining that a convergence criterion is met based on no transactions changing a previously-assigned identifier over a predefined number of iterations, wherein the iterations include repeatedly sorting and assigning the unique transaction identifier based on predefined criteria until the previously-assigned identifier remains unchanged;
determining whether each group of transactions among the second plurality of groups of transactions is a sequence of fraudulent transactions based on (i) determining that the convergence criterion is met and (ii) one or more features including a transaction frequency metric, a distribution of transaction value, a temporal or structural pattern of modifications to transaction parameters, or an indicator of missing transaction parameter;
determining whether the group of transactions exceed a predefined threshold of a potentially fraudulent activity, wherein the predefined threshold is based on a count of one or more unique account numbers, one or more unique billing addresses, or one or more unique phone numbers;
filtering one or more transactions with known legitimate parameters from the group of transactions identified as potentially fraudulent, wherein the known legitimate parameters include transactions associated with one or more predefined transaction patterns or exceptions;
upon determining that a group of transactions among the second plurality of groups of transactions is a sequence of fraudulent transactions, denying authorization requests for each transaction among the determined group of transactions from among the authorization requests sent across the payment network; and
transmitting electronic reports that respectively report transactions associated with the respective denied authorization requests to respective holders of payment accounts associated with the respective transactions.

16. The non-transitory machine-readable medium of claim 15, the method further comprising:
determining whether each transaction among the determined group of transactions is legitimate; and
upon determining that a transaction among the determined group of transactions is legitimate, marking the transaction as not potentially fraudulent.

17. (canceled)

18. The non-transitory machine-readable medium of claim 15, wherein one or more operations of sorting the plurality of transactions, and assigning the unique transaction identifier of a respective transaction to all other transactions within the respective group of transactions, are repeated until all related transactions are grouped together.

19. The non-transitory machine-readable medium of claim 15, wherein the first sorting parameter and the second sorting parameter comprise one or more of a payment account number, an account holder first name, an account holder surname, a payment account street address, a payment account state code, a payment account zip code, a card verification value (CVV), a transaction amount, and an internet protocol (IP) address of a device from which the respective transaction originated.

20. The non-transitory machine-readable medium of claim 15, wherein determining whether each group of transactions is a sequence of fraudulent transactions is based on a pattern of changes to a transaction parameter within the group of transactions or a common missing transaction parameter within the group of transactions.
